(19) United States
(12) Patent Application Publication
(10) Pub. No.: US 2022/0055331 A1
(43) Pub. Date: Feb. 24, 2022

(54) SHAPING APPARATUS AND SHAPING METHOD FOR SHAPING A WORKPIECE, AND COMPUTER-READABLE NON-TRANSITORY MEDIA ABLE TO PERFORM THE SHAPING METHOD

(71) Applicant: INDUSTRIAL TECHNOLOGY RESEARCH INSTITUTE, HSINCHU (TW)

(72) Inventors: Po-Huang SHIEH, Zhunan Township (TW); Po-Nien TSOU, Tainan City (TW); Hsuan-Yu HUANG, Taipei City (TW); Wei-Chieh CHANG, Zhubei City (TW)

(73) Assignee: INDUSTRIAL TECHNOLOGY RESEARCH INSTITUTE, HSINCHU (TW)

(21) Appl. No.: 17/081,372

(22) Filed: Oct. 27, 2020

(30) Foreign Application Priority Data
Aug. 18, 2020 (TW) 109128076

(51) Int. Cl. B30B 7/04; B21D 53/78; B30B 15/14

(52) U.S. Cl. CPC B30B 7/04; B30B 15/14; B21D 53/78

(57) ABSTRACT

A shaping apparatus for shaping a workpiece includes a controlling module and a pressing module, a moving module, a sensing module and a shaping calculation module that are connected to the controlling module. The pressing module includes two pressing elements respectively applying load to a top/bottom surface of the workpiece. The moving module includes a moving platform moving the workpiece horizontally between a sensing zone and a processing zone. The sensing module performs a capturing process on the workpiece in the sensing zone to obtain a surface information. The shaping calculation module compares the surface information with an ideal shape data to calculate and get a shaping information. The moving platform moves the workpiece to the sensing zone. The sensing module performs a capturing process on the workpiece. The moving platform moves the workpiece to the processing zone. The pressing module performs a shaping treatment on the workpiece.

This application claims the benefit of Taiwan application Serial No. 109128076, filed Aug. 18, 2020, the disclosure of which is incorporated by reference herein in its entirety.

### TECHNICAL FIELD

The disclosure relates in general to a shaping apparatus shaping method for shaping a workpiece and the shaping method, and a computer-readable non-transitory medium able to perform the shaping method.

### BACKGROUND

Currently, the conventional shaping process of a workpiece is manually performed by related practitioners according to their experience and the human visual aided judgment. However, manual shaping process is time consuming and the human visual aided judgment still has reliability problem. Additionally, the long duration of manual operation is a chronic jeopardy to the workers. Although machinery is used in the shaping process, most machinery is a one-dimensional or a two-dimensional shaping apparatus and cannot meet further requirements. Therefore, it has become a prominent task for related practitioners of the present field to provide an automatic and high-precision three-dimensional shaping apparatus and method for shaping the workpiece.

### SUMMARY

The disclosure is directed to a shaping apparatus and shaping method for shaping a workpiece and a computer-readable non-transitory medium able to perform the shaping method to resolve the existing problems of the prior art.

According to one embodiment, a shaping apparatus for shaping a workpiece is provided. The apparatus includes a controlling module and a pressing module, a moving module, a sensing module and a shaping calculation module that are connected to the controlling module. The pressing module includes two pressing elements respectively applying load to a top surface and a bottom surface of the workpiece. The moving module includes a moving platform moving the workpiece horizontally between a sensing zone and a processing zone, and a workpiece carrier clamping and moving the workpiece multi-axially. The sensing module performs a capturing process on the workpiece in the sensing zone to obtain a surface information about the workpiece. The shaping calculation module compares the surface information with an ideal shape data to calculate and get a shaping information about the workpiece. The controlling module controls the moving platform to move the workpiece to the sensing zone and controls the sensing module to perform a capturing process on the workpiece, and further controls the moving platform to move the workpiece to the processing zone and controls the pressing module to perform a shaping treatment on the surface of the workpiece according to the shaping information.

According to another embodiment, a shaping method for shaping the surface of a workpiece is provided. The shaping method includes the following steps: operating a shaping apparatus, wherein the shaping apparatus comprises a pressing module, a moving module, a sensing module, a shaping calculation module and a controlling module; controlling the moving module by the controlling module to move the workpiece to a sensing zone; controlling the sensing module by the controlling module to perform a capturing process on the workpiece in the sensing zone to obtain a surface information about the workpiece; comparing the surface information with an ideal shape data by the shaping calculation module to calculate and get a shaping information about the workpiece; controlling the moving module by the controlling module to move the workpiece to a processing zone; controlling the pressing module by the controlling module to perform a shaping treatment on the surface of the workpiece according to the shaping information; and determining whether the shape-treated workpiece complies with an allowable error range by the controlling module.

According to an alternate embodiment, a computer-readable non-transitory medium storing a program is provided. After the computer-readable non-transitory medium loads the program, the computer-readable non-transitory medium performs the shaping method according to any embodiment of the present invention.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1 is a 3D diagram of a shaping apparatus according to an embodiment of the present invention.

FIG. 2 is a side view of a shaping apparatus according to an embodiment of the present invention.

FIG. 3 is a conceptual architecture diagram of a shaping apparatus according to an embodiment of the present invention.

FIG. 4 is a flowchart of a shaping method according to an implementation of the present invention.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

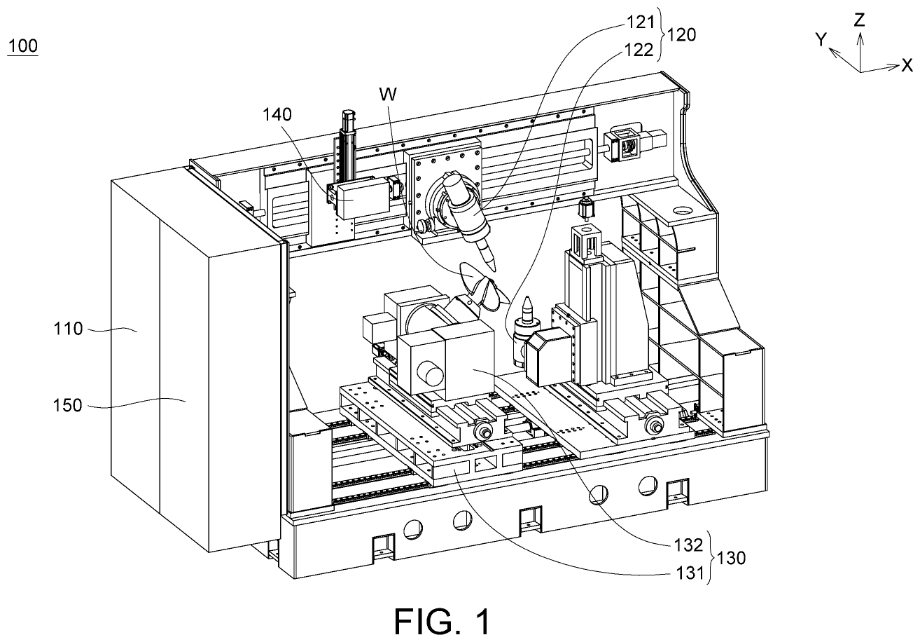

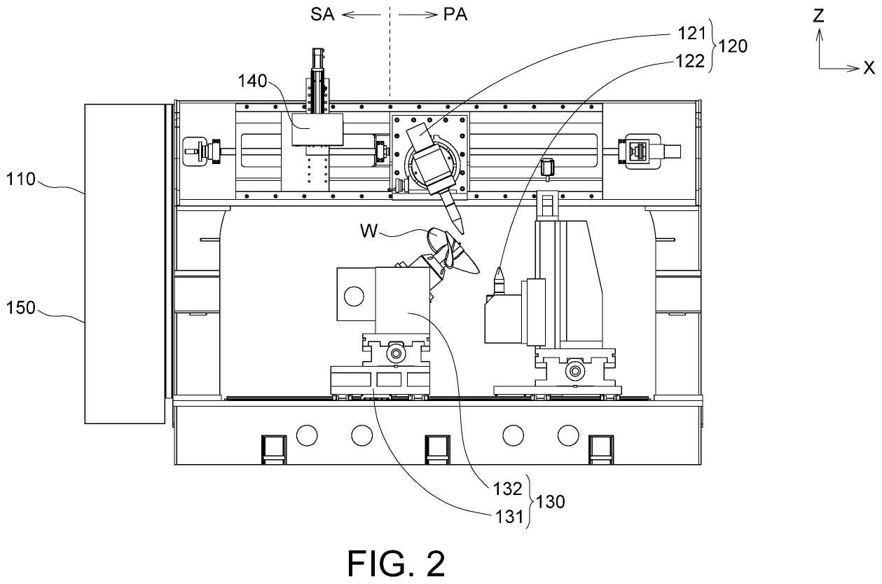

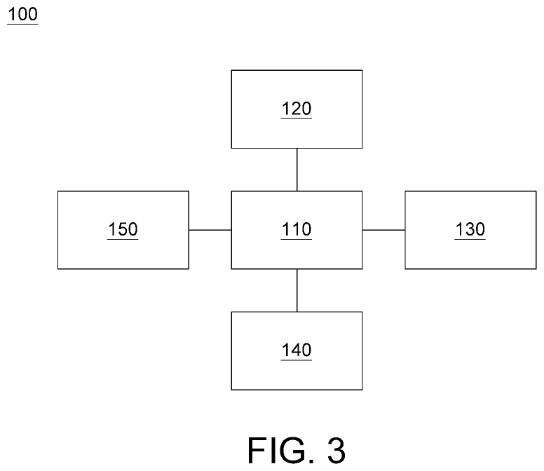

FIG. 1 is a 3D diagram of a shaping apparatus 100 according to an embodiment of the present invention. FIG. 2 is a side view of a shaping apparatus 100 according to an embodiment of the present invention. FIG. 3 is a conceptual architecture diagram of a shaping apparatus 100 according to an embodiment of the present invention.

Refer to FIGS. 1-2, a 3D diagram and a side view of a shaping apparatus 100 for shaping a workpiece W are shown. The workpiece W can be realized by an aviation propeller provided with at least one paddle-like structure or blade. The shaping apparatus 100 is for shaping the paddle-like structure or the blade of the aviation propeller, but the present invention is not limited thereto. As indicated in FIGS. 1-3. The shaping apparatus 100 includes a controlling module 110, a pressing module 120, a moving module 130, a sensing module 140 and a shaping calculation module 150, wherein the pressing module 120, the moving module 130, the sensing module 140 and the shaping calculation module 150 all are connected to the controlling module 110. In another implementation of the present invention, the shaping calculation module 150 can be independent of other modules of the shaping apparatus 100 and can be connected to the controlling module 110 through wireless communication. The shaping calculation module 150 of the implementation can be configured in an external cloud server connected to the controlling module 110 through the Internet.

The pressing module 120 includes two pressing elements, namely pressing element 121 and pressing element 122, respectively applying load on a top surface and a bottom surface of the workpiece W to squeeze and shape the surface of the workpiece W through contact pressure. In an embodiment, the pressing module 120 can be realized by a fluid actuation module selected from a hydraulic actuation module, a pneumatic actuation module or a combination thereof. Correspondingly, the pressing elements 121 and 122 of the pressing module 120 can be realized by two hydraulic actuation rods, two pneumatic actuation rods, or a combination of a hydraulic actuation rod and a pneumatic actuation rod.

The moving module 130 includes a moving platform 131 and a workpiece carrier 132. The moving platform 131 is configured to move the workpiece W horizontally (such as the X-axis direction of FIG. 2) between a sensing zone SA and a processing zone PA. The workpiece carrier 132 is configured to clamp the workpiece W and multi-axially move the workpiece W. To put it in greater details, the moving platform 131 can move the workpiece W between the sensing zone SA and the processing zone PA, such that a three-dimensional contour of the workpiece can be sensed in the sensing zone SA to obtain a feedback of the contour shape; and the workpiece can be shaped in the processing zone PA to obtain an ideal contour shape. Detailed descriptions of the sensing and shaping operations are disclosed below. Specifically, the workpiece carrier 132 can translate or rotate the workpiece W along the Y-axis direction, rotate the workpiece W along the X-axis direction, and translate the workpiece W along the Z-axis direction to move the workpiece W multi-axially. It should be understood that to fit the practitioners' actual needs, the workpiece carrier 132 can cooperate with other elements (such as the pressing module 120 and the moving platform 131) to move in a three-dimensional space with 6 degrees of freedom.

The sensing module 140 is configured to perform a capturing process on the workpiece W in the sensing zone SA to obtain a surface information about the workpiece W. In an embodiment, the sensing module 140 can sense the to-be-shaped surface of the workpiece W to obtain at least one of the information including material, contour and surface undulation of the workpiece W (such as the distribution of the protrusion or depression on the surface). In another embodiment, the sensing module 140 can sense the top surface of the workpiece W (such as the surface pressed by the pressing element 121) to obtain at least one of the information including the material, the contour, and the surface undulation of the workpiece W (such as the distribution of the protrusions or depressions on the surface). Or, in another embodiment, the sensing module 140 can sense the bottom surface of the workpiece W (such as the surface pressed by the pressing element 122) to obtain at least one of the information including the material, the contour, and the surface undulation of the workpiece W (such as the distribution of the protrusions or depressions on the surface).

In an embodiment, the sensing module 140 can be realized by a three-dimensional contour capturer configured to capture a three-dimensional contour of the workpiece W, wherein the three-dimensional contour capturer can selectively use a light sensor (such as a structured light sensor or a laser light sensor) or a probe. The light sensor is configured to perform a non-contact type contour scanning on the workpiece W. The light sensor has higher sensing rate and higher sampling frequency and does not damage the surface of the workpiece. The probe is configured to perform a contact type contour capturing process on the workpiece W. The probe has higher measuring precision and reliability and is not affected by the reflection characteristics of the surface of the workpiece.

The shaping calculation module 150 is configured to compare the surface information with an ideal shape data to calculate and get a shaping information about the workpiece W. Specifically, the ideal shape data is stored in a database of the shaping calculation module 150 and corresponds to a design model on which the manufacturing of the workpiece W is based. For example, the design model is a design drawing (such as a CAD model) on which the manufacturing of the workpiece W is based. The shaping calculation module 150 compares the sensed surface information with the actual design of the workpiece to calculate and get an optimal configuration for shaping the workpiece. To put it in greater details, the shaping calculation module 150 analyzes the shaping position and deformation about the workpiece W according to a comparison between the surface information and an ideal contour data to obtain an optimal configuration for shaping the workpiece W. In comparison to the human visual aided judgment used in the prior art, the shaping calculation module 150 of the present invention produces higher precision.

In an embodiment, the shaping calculation module 150 is configured to analyze an error of the surface information in comparison to the design model according to at least one of the surface undulation, the deformation type, and the deformation position of the workpiece W. To put it in greater details, the shaping calculation module 150 analyzes an error between a surface information of the workpiece W obtained by the sensing module 140 and an ideal design stored in a database of the shaping calculation module 150 according to the difference in the surface undulation, the workpiece deformation, and the deformation position.

Specifically, the shaping information includes at least one of the shaping correction position of the workpiece W, the feed of the pressing module 120, the processing position of the pressing module 120, the pressure value of the pressing module 120, and the speed of the pressing module 120.

In an embodiment, the feed of the pressing module 120 can be set to be greater than 0.01 mm; and/or the speed of the pressing module 120 can be set to be 1-50 mm/s; and/or the pressure value of the pressing module 120 can be set to be 0.1-10 Ton; and/or the amount of feed for the shaping correction position of the workpiece W can be set to be greater than 0.1 mm.

The controlling module 110 is configured to control the moving platform 131 to move the workpiece W to the sensing zone SA and control the sensing module 140 to perform a capturing process on the workpiece W. The controlling module 110 is further configured to control the moving platform 131 to move the workpiece W to the processing zone PA and control the pressing module 120 to perform a shaping treatment the surface of the workpiece W according to the shaping information. In an embodiment, the controlling module 110 is further configured to adjust the multi-axial movement (that is, the X-axis, the Y-axis, and the Z-axis of the diagram) between the workpiece carrier 132 and the pressing elements 121 and 122 to perform a multi-axial machining process on the surface of the workpiece W. In an embodiment, the controlling module 110 is further configured to set a sensing parameter of the sensing module 140, wherein the sensing parameter includes at least one of the capturing number, the view range, and the number of observation point of the sensing module 140.

As disclosed above, the workpiece W can be realized by an aviation propeller provided with at least one paddle-like structure or blade, and the capturing number of the sensing module 140 is determined according to the number of paddle-like structures. For example, given that the number of the paddle-like structures of the workpiece W is 3, correspondingly the capturing number is 3, but the present invention is not limited thereto. Specifically, the view range refers to the range of the surface of the workpiece W sensed by the sensing module 140, and can be correspondingly adjusted as a range or a complete contour of the workpiece W. Specifically, the number of observation point refers to the number of observation point sampled on the surface of the workpiece W during the sensing process. The number of observation point is determined as required by related practitioners. For example, when measuring the edge of the workpiece, a number of observation point can be set on the edge of the workpiece; or when measuring the center of the workpiece, one observation can be set at the center of the workpiece. Thus, the observation point can be adjusted to fit actual needs, and the arrangement of the observation point can also be adjusted according to actual needs. For example, the observation point can be arranged in the form of a matrix or in the form of concentric circles, but the present invention is not limited thereto.

In an embodiment, the controlling module 110 sets the sensing parameter of the sensing module 140 according to a classification number about the workpiece W, and the classification number corresponds to the type of the workpiece W. To put it in greater details, after a number of workpieces W are manufactured and are ready to leave the factory, the workpieces W are classified as N different classification numbers (such as 1 to 5) by related practitioners. The classification number can be assigned according to the size, the material or the appearance of the product. Since each classification number corresponds to a product type (such as type A to type E), the ideal shape to be achieved by way of shaping also varies with the product type. Therefore, the sensing parameter of the sensing module 140 is correspondingly set by the controlling module 110 according to the classification number.

In an embodiment, after the controlling module 110 controls the pressing module 120 to perform a shaping treatment on the surface of the workpiece W according to the shaping information, the controlling module 110 can further control the moving platform 131 to move the workpiece W to the sensing zone SA and control the sensing module 140 to perform a capturing process on the workpiece W. Then, the controlling module 110 determines whether the shape-treated workpiece W complies with an allowable error range or not. The allowable error range is determined according to the shaping specifications of the workpiece as required by related practitioners (for example, whether the degree of bending of the surface of the workpiece complies with the requirement, or whether the straightness on the surface of the workpiece complies with the requirement), and can be adjusted according to actual needs.

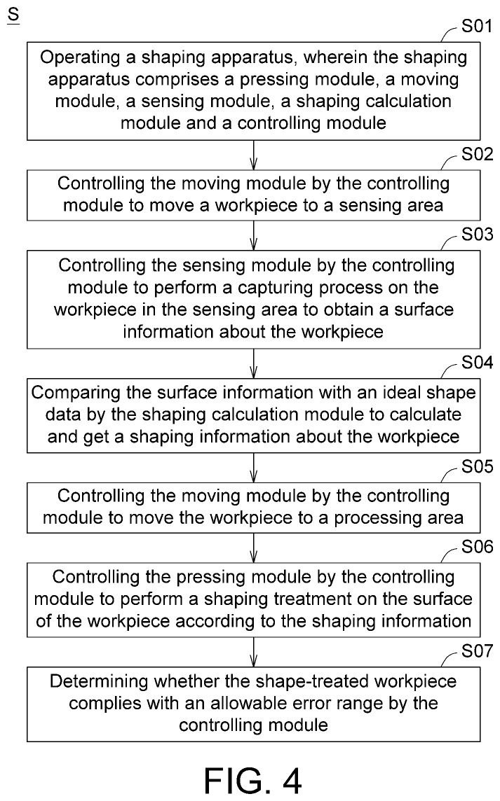

FIG. 4 is a flowchart of a shaping method S according to an implementation of the present invention.

It should be understood that the shaping method S of the present invention can be used for shaping a workpiece (such as the workpiece W disclosed above), and the shaping method of the present invention can be used in the shaping apparatus 100, therefore the shaping method S is applicable to the various implementations and modifications of the shaping apparatus 100 disclosed above.

As indicated in FIG. 4, the shaping method S of an implementation of the present invention includes step S01 to step S07.

In step S01: operating a shaping apparatus 100, wherein the shaping apparatus 100 includes a pressing module 120, a moving module 130, a sensing module 140, a shaping calculation module 150 and a controlling module 110;

In step S02: controlling the moving module 130 by the controlling module 110 to move a workpiece W to a sensing zone SA;

In step S03: controlling the sensing module 140 by the controlling module 110 to perform a capturing process on the workpiece W in the sensing zone SA to obtain a surface information about the workpiece W;

In step S04: comparing the surface information with an ideal shape data by the shaping calculation module 150 to calculate and get a shaping information about the workpiece W;

In step S05: controlling the moving module 130 by the controlling module 110 to move the workpiece W to the processing zone PA;

In step S06: controlling the pressing module 120 by the controlling module 110 to perform a shaping treatment on the surface of the workpiece W according to the shaping information;

In step S07: determining whether the shape-treated workpiece W complies with the allowable error range by the controlling module 110.

In a concrete implementation, step S03 of the shaping method S of the present invention further includes following details: a sensing parameter of the sensing module 140 is set by the controlling module 110, wherein the sensing parameter includes at least one of the capturing number, the view range, and the number of observation point of the sensing module 140. Thus, the desired parameters can be set according to the needs of related practitioners, and the setting can be flexibly adjusted in response to the needs.

In a concrete implementation, step S07 of the shaping method S of the present invention further includes following details: the moving module 130 is controlled by the controlling module 110 to move the workpiece W to the sensing zone SA, and the sensing module 140 is controlled to perform a capturing process on the workpiece W in the sensing zone SA to determine whether the shape-treated workpiece W complies with the allowable error range or not. If the determination is negative, then the controlling module 110 controls the moving module 130 to move the workpiece W to the processing zone PA. Thus, the shaping treatment can again be performed on the workpiece W. The step of determining whether the shape-treated workpiece W complies with the allowable error range can be performed repeatedly until the workpiece W complies with the allowable error range. Thus, a loop detection can be achieved to implement an optimum automatic operation for shaping the workpiece W.

Besides, the shaping method of the present invention can also be used in a computer-readable non-transitory medium storing a program. After the computer-readable non-transitory medium loads in the program, the computer-readable non-transitory medium can perform the shaping method of the present invention to replace manual shaping operation with automatic shaping operation.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A shaping apparatus for shaping a workpiece, wherein the shaping apparatus comprises:
a controlling module;
a pressing module connected to the controlling module, wherein the pressing module comprises two pressing elements respectively applying load to a top surface and a bottom surface of the workpiece;
a moving module connected to the controlling module, wherein the moving module comprises a moving platform and a workpiece carrier, the moving platform is configured to move the workpiece horizontally between a sensing zone and a processing zone, and the workpiece carrier is configured to clamp the workpiece and multi-axially move the workpiece;
a sensing module connected to the controlling module, wherein the sensing module is configured to perform a capturing process on the workpiece in the sensing zone to obtain a surface information about the workpiece; and
a shaping calculation module connected to the controlling module, wherein the shaping calculation module is configured to compare the surface information with an ideal shape data to calculate and get a shaping information about the workpiece;
wherein, the controlling module is configured to control the moving platform to move the workpiece to the sensing zone and control the sensing module to perform a capturing process on the workpiece, and the controlling module is further configured to control the moving platform to move the workpiece to the processing zone and control the pressing module to perform a shaping treatment on the surface of the workpiece according to the shaping information.

2. The shaping apparatus according to claim 1, wherein the sensing module is a three-dimensional contour capturer configured to capture a three-dimensional contour of the workpiece.

3. The shaping apparatus according to claim 2, wherein the three-dimensional contour capturer is a light sensor configured to perform a non-contact type contour scanning process on the workpiece.

4. The shaping apparatus according to claim 2, wherein the three-dimensional contour capturer is a probe configured to performs a contact type contour capturing process on the workpiece.

5. The shaping apparatus according to claim 3, wherein the light sensor is a structured light sensor or a laser light sensor.

6. The shaping apparatus according to claim 1, wherein the surface information comprises at least one of material, contour and surface undulation of the workpiece.

7. The shaping apparatus according to claim 1, wherein the controlling module is further configured to adjust the multi-axial movement between the workpiece carrier and the two pressing elements to perform a multi-axial machining process on the surface of the workpiece.

8. The shaping apparatus according to claim 1, wherein the controlling module is further configured to set a sensing parameter of the sensing module, and the sensing parameter comprises at least one of capturing number, view range, and number of observation point of the sensing module.

9. The shaping apparatus according to claim 8, wherein the controlling module sets the sensing parameter of the sensing module according to a classification number about the workpiece, and the classification number corresponds to the type of the workpiece.

10. The shaping apparatus according to claim 8, wherein the workpiece having at least one paddle-like structure, and the capturing number of the sensing module is determined according to number of the paddle-like structure.

11. The shaping apparatus according to claim 1, wherein the ideal shape data is stored in a database of the shaping calculation module and corresponds to a design model on which the manufacturing of the workpiece is based.

12. The shaping apparatus according to claim 11, wherein the shaping calculation module is configured to analyze an error of the surface information in comparison to the design model according to at least one of surface undulation, deformation type, and deformation position of the workpiece.

13. The shaping apparatus according to claim 1, wherein the shaping information comprises at least one of shaping correction position of the workpiece and feed of the pressing module, processing position of the pressing module, pressure value of the pressing module, and speed of of the pressing module.

14. The shaping apparatus according to claim 1, wherein the pressing module is a fluid actuation module.

15. The shaping apparatus according to claim 1, wherein the controlling module is configured to control the moving platform to move the workpiece to the sensing zone and control the sensing module to perform a capturing process on the workpiece, and the controlling module is configured to determine whether the shape-treated workpiece complies with an allowable error range.

16. A shaping method for shaping the surface of a workpiece, wherein the shaping method comprises the following steps:
operating a shaping apparatus, wherein the shaping apparatus comprises a pressing module, a moving module, a sensing module, a shaping calculation module and a controlling module;
controlling the moving module by the controlling module to move the workpiece to a sensing zone;
controlling the sensing module by the controlling module to perform a capturing process on the workpiece in the sensing zone to obtain a surface information about the workpiece;
comparing the surface information with an ideal shape data by the shaping calculation module to calculate and get a shaping information about the workpiece;
controlling the moving module by the controlling module to move the workpiece to a processing zone;
controlling the pressing module by the controlling module to perform a shaping treatment on the surface of the workpiece according to the shaping information; and
determining, by the controlling module, whether the shape-treated workpiece complies with an allowable error range.

17. The shaping method according to claim 16, wherein the step of controlling the sensing module by the controlling module to perform a capturing process on the workpiece in the sensing zone further comprises:
setting a sensing parameter of the sensing module by the controlling module, wherein the sensing parameter comprises at least one of the capturing number, the view range, and the number of observation point of the sensing module.

18. The shaping method according to claim 17, wherein the controlling module sets the sensing parameter of the sensing module according to a classification number about the workpiece, and the classification number corresponds to the type of the workpiece.

19. The shaping method according to claim 17, wherein the workpiece having at least one paddle-like structure, and the capturing number of the sensing module is determined according to number of the paddle-like structures.

20. The shaping method according to claim 16, wherein the ideal shape data is stored in a database of the shaping calculation module and corresponds to a design model on which the manufacturing of the workpiece is based.

21. The shaping method according to claim 16, wherein in the step of comparing the surface information with an ideal shape data by the shaping calculation module to calculate and get a shaping information about the workpiece, the shaping calculation module is configured to analyze an error of the surface information in comparison to the design model according to at least one of surface undulation, deformation type, and deformation position of the workpiece.

22. The shaping method according to claim 16, wherein the shaping information comprises, with respect to the shaping correction position of the workpiece, at least one of feedof of the pressing module, processing position ofof the pressing module, pressure value of ofthe pressing module and speed ofof the pressing module.

23. The shaping method according to claim 16, wherein, the step of determining, by the controlling module, whether the shape-treated workpiece complies with the allowable error range further comprises:
controlling the moving module by the controlling module to move the workpiece to the sensing zone, and controlling the sensing module to perform a capturing process on the workpiece in the sensing zone to determine whether the shape-treated workpiece complies with the allowable error range; if the determination is negative, then the controlling module controls the moving module to move the workpiece to the processing zone.

24. A computer-readable non-transitory medium storing a program, wherein after the computer-readable non-transitory medium loads in the program, the computer-readable non-transitory medium performs the shaping method according to claim 16.
